(19) United States
(12) Patent Application Publication
(10) Pub. No.: US 2005/0259446 A1
(43) Pub. Date: Nov. 24, 2005

(54) Decorative night light

(76) Inventors: Matthew S. Smith, St. Charles, MO (US); James J. Riley, St. Louis, MO (US)

Correspondence Address: Paul M. Denk, Ste. 170, 763 S. New Ballas Road, St. Louis, MO, 63141, US

(21) Appl. No.: 11/128,457

(22) Filed: May 13, 2005

Related U.S. Application Data
(60) Provisional application No. 60/571,460, filed on May 14, 2004.

(51) Int. Cl. F21L 4/00

(52) U.S. Cl. 362/641

(57) ABSTRACT

A variable night light formed from a variety of vehicles, military and civilian, airplanes, or other structures or caricatures, configured into a night light, and which provides for a low level of illumination upon plugging into the wall, or by a switch can function as this invention. The source of illumination may either be a low intensity lamp, LED, or other light emitting device, and when energized may also incorporate a motion detector which can initiate the emanation of a sound, from the night light, during usage, compatible with the type of structure as displayed from the night light during its usage.

### CROSS REFERENCE TO RELATED APPLICATION

This non-provisional patent application claims priority to the provisional application Ser. No. 60/571,460 filed on May 14, 2004.

### BACKGROUND OF THE INVENTION

This invention relates generally to illumination devices, and more particularly relates to aesthetically decorative night lights that may be applied in children's rooms, hallways, and the like.

Numerous night lights have been available in the art. Generally these are either molded of plastic, having a singular design, shaped like a small evergreen tree, mushroom, or any of a variety of shapes, as has been envisioned. Most of these plug into a standard 110 volt AC outlet to function. Such night lights usually include a lamp, to which the plastic shield is applied to or clamped thereto, and the clamp screws into a small socket that contains the prongs for inserting into a wall socket, as along the base of a children's room, hallway, long steps, and the like, particularly in the vicinity of where children reside and roam.

The concept of this current invention is to provide a further innovation into such a night light, so as to add to versatility, attractiveness, and usefulness, for functioning for illumination purposes, at a moderately low amount of light, and particularly during the night hours.

### SUMMARY OF THE INVENTION

This invention contemplates a new style of night light for application to various rooms, halls, steps, and the like. The new night light adds safety, and enhances the attractiveness and novelty of such a light, during usage.

In the basic invention, a night light for this invention includes one which applies a customizable style of element, such as the frontal part of a vehicle, into the configuration of the night light, or which may be replaceably applied, by any type of clasp or holder, such that when the night light is plugged in, a light within the vehicle or other shape, will illuminate, to provide the standard quantity of lower level lumens, during the night. But, at the same time, the light will illuminate the attractiveness of the shape, whether it is the front end of a vehicle, or that of an entire military vehicle or a racing car, which will incorporate windows, so as to allow the internally generated and arranged light to illuminate and radiate therethrough, to provide for lighting, and exciting aesthetics. Such light sources may include a small lamp, or perhaps LED arranged at strategic locations around the perimeter of the vehicle, preferably on the interior, to add to their lighting and attractiveness.

In the preferred embodiment, the images show that the car is cut approximately in half, or just behind the driver's seat, in the vicinity of the back passenger seat. The car extends forward out of the night light cover plate, and perhaps contains electrical contacts, at the back side, that may be plugged directly into an electrical socket, to provide for the style of illumination as previously described.

This particular style of night light can plug directly into the wall socket, and create the effects of a vehicle coming out of the wall. This may also resemble a vehicle riding on the wall itself, or on a recreated surface, such as where the base plate for the night light may be formed to appear like ground, asphalt, cloud, or other material, and with the vehicle or other shape radiating out of the same. In addition to using vehicles, the night light may incorporate and represent other characters or situations, as can be understood. The night light may also feature various sounds, including but not limited to, an engine revving, shooting, explosions, jet engines when an airplane is configured to be plugged into the socket, squealing tires, honking, wind, thunder, animal sounds, cheering crowds, voices, music, sirens, rotor sounds, and alarms, among other things.

The night light may also feature lights from a variety of sources, including but not limited to LED, incandescent lamps, electro-luminescent shapes, fluorescents, fiber optics, LCD and glowing plastics or organic light emitting diodes. Such lights may also be programmed to create effects, such as but not limited to, tracer lights, strobe lights, flashing, illumination of hidden items, and the like.

The night light may also incorporate circuitry to furnish motorized features, such as the turning or spinning of objects, lifting of objects, both visible and hidden, but yet to be revealed, objects changing position, objects changing shapes, and the like. The lights may also feature motion detectors, or manual switches built in to activate any of the above, in the event that someone walks past the night light.

Further to the foregoing, it is just as likely that the night light, in addition to the showing of the front end of a car, tank, airplane, or the like, could also provide for the extension forward of a segment of an aircraft, submarine, spacecraft, or other shape, and incorporate means for inducing and generating sounds simulating the sound that might emanate from the vehicle shown during its usage and application. It is also likely that the night light of this invention may be made portable and battery operated. The present invention may simulate something similar to a music player, message holder, room alarm, pencil sharpener, voice message recorder, and may even have magnets that are supplied to the back side of its plate. The magnets allow the present invention to be arranged and affixed to the inside of a locker door, locker wall, or the like, as can be understood, so as to provide lighting therein, and be battery operated, as can further be envisioned.

In any event, the concept of the invention is to add a customizable décor switch component to adhere, fix, or fasten as a night light that may plug directly into an electric socket, such as a wall socket. In addition, as noted, it may even include some battery operated components, so that it may be affixed to a wall, independently illuminated, such as a locker wall, or a room wall, held by means of magnets, pressure sensitive adhesive, or the like. Eventually, the means for fastening and illuminating are the technical aspects of the invention, and which are generally intended to provide and accomplish a variation in the aesthetics of the night light, or other instrument, during usage.

The object is to create a visual and physical change to an existing night light, to give it character, and to relay an attitude reflecting the graphic treatment of the light, and at the same time, provide other and alternative aspects, as can be understood. For example, a night light may have other shapes upon its surfaces including faces or the like and may even emanate sounds and words, associated with the face that it may portray, such as can be done through micro-circuitry, or a computer chip, and can portray the voice of a prominent athlete, actor, actress, politician, and the like, all of which can be embodied in a night light, and generate a sound. In addition, the light itself may be illuminated, so that it can be seen at night, and provide a low level of light for its location. Presently, a chip can be provided with micro-circuitry to emanate and transmit a sound similar to known sounds and voices, and which could be built into the structure of this night light. A motion sensor can be built within the night light, so as to initiate a voice, or other sound, such as that of the vehicles as previously reviewed, especially when anyone walks within the vicinity of the night light.

Electrically, where the device plugs into an existing 110 volt AC line, it may include a step down transformer that may be required to reduce the voltage, and to provide the type of lower power sufficient to activate the light, any sounds, or other activating devices, that operate off of a lower voltage. In any event, it should be understood that the concept of this invention is to incorporate light, perhaps sound, and even some motion, into a night light that may be either plugged into a wall socket, or operate from a battery during usage.

It is, therefore, the principal object of this invention to provide a highly caricatured or animated type of a shape with sounds that functions as a night light, and which can be activated by turning on manually, motion, heat, or the like, to furnish an exciting type of illumination, and further transmit sounds, voice, and the like, when actuated.

These and other objects may become more apparent to those skilled in the art upon review of the summary of the invention as provided herein, and upon undertaking a study of its preferred embodiment in view of the drawings.

### BRIEF DESCRIPTION OF THE DRAWINGS

In referring to the drawings, FIG. 1 discloses an embodiment of a night light of this invention comprising the front end of a vehicle, that plugs directly into a wall socket, and which illuminates itself therein, for producing a low level of light;

FIG. 2 describes a night light in the style of the full body of a racing car that plugs into a wall socket from the side of the car;

FIG. 3 discloses a night light fabricated in the style of a military tank, and which can be plugged into a wall socket, which when illuminated, will furnish light through its translucent frame, and also may emit an appropriate sound as from within;

FIG. 4 shows the front half of a racing vehicle, which when plugged into the wall socket, furnishes low level illumination, and also, may have a motion sensor in the vicinity of its grill, which will actuate the sound of a racing vehicle, during energization; and

FIG. 5 shows a brief schematic for circuitry of how the vehicle style of night light, as shown in FIG. 1, can be installed into an electrical socket, or even rendered operative through a motion sensor.

### DESCRIPTION OF THE PREFERRED EMBODIMENT

In referring to the drawings, in particular FIG. 1, the night light 1 of this invention is disclosed. It includes a standard electrical outlet plate 2, having a double configuration, incorporating a pair of electric sockets 3, as is well known in the art. The concept of this invention is to provide a night light 4 or lamp reflector, which is the frontal end of a racing vehicle, having various translucent windows 5, through which light will emanate from an illuminating means, when the vehicle is plugged into the wall socket, to function just as a night light. The light will be located within the structure of the vehicle, and energized, when it is plugged in.

As also referred to, and as summarized, other means may be provided within the structure of this device so as to actuate any sounds, or the like, during its usage and application. As stated, the night light includes lights and sounds activated by a switch and/or motion, during usage.

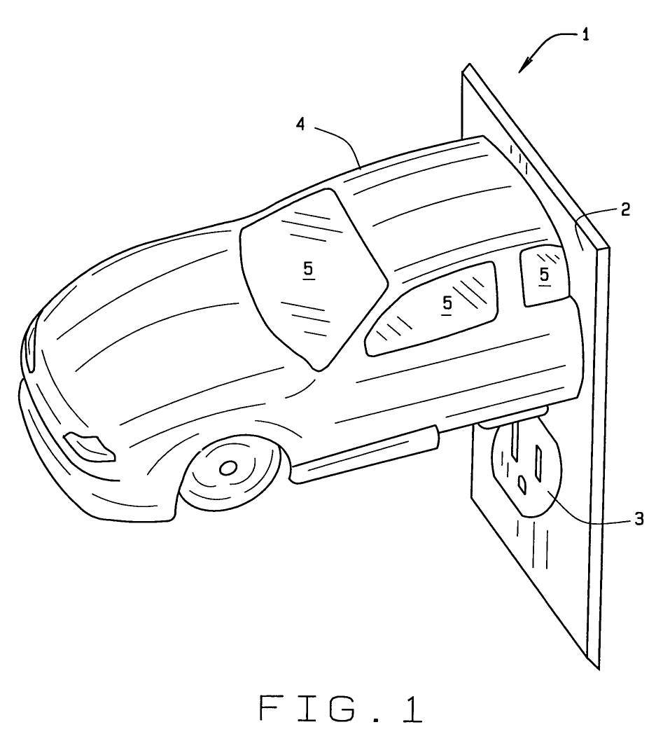

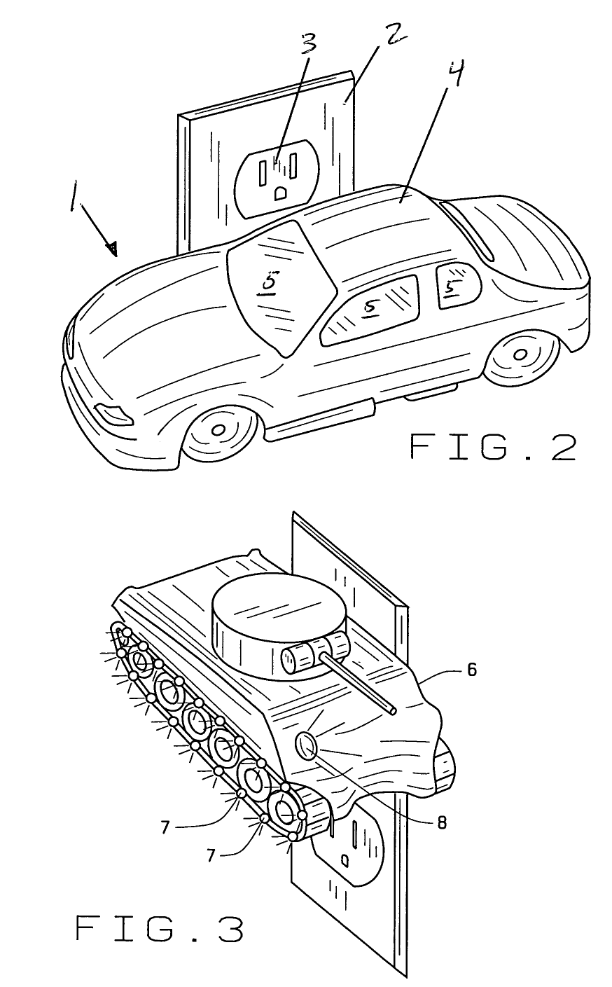

FIG. 2 discloses a racing car and FIG. 3 discloses a military vehicle, such as a tank 6, that when plugged into the wall, will provide for an illumination of a light, which may be reflected out of the various stations around the perimeter of the tank, such as along its treads 7, and out of its headlights 8, or the body of the tank may also be made of translucent material, so that the entire racing car, tank, or military vehicle is illuminated, and radiates some low level of light to function as a night light. In addition, light may be emitted from the bottom of the tank in order to afford that type of lighting feature, such as along the ground or steps, where such a light may be installed. Furthermore, any type of a motion actuator or other switch can provide for the emanation of a sound, such as that simulating a moving car or running tank, during a segment or all of its usage, when energized.

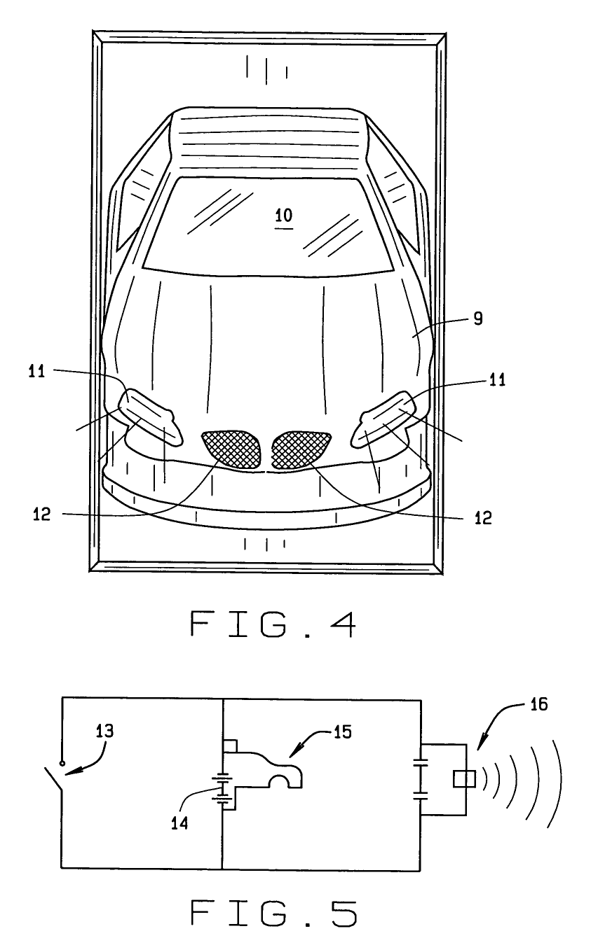

The racing vehicle 9, shown in FIG. 4, likewise plugs into the wall socket, and when illuminated, light may emanate from the entire body of the vehicle, or through its windows 10, or even forwardly out of its headlights 11, during energization. In addition, a motion sensor may be directed out of the grill work 12 of the vehicle. The motion sensor when actuated, as by a passing individual or pet causes the sound of a racing car to be emitted from its circuitry, computer chip, or microchip provided therein for generating sound comparable to the vehicle when the night light is installed, initiated, and energized.

A brief example of the type of circuitry that may be used with this invention can be seen in FIG. 5. This is simply a circuit which discloses a switch, as at 13, that provides energy to a wall socket 14, so that when one of the night lights 15 of this invention is installed, provides the type of light, sounds, and the like, as previously described, with respect to the vehicles as shown and described in FIGS. 1-4 of this application.

Or, a motion sensor 16, as known in the art, can be provided within the circuitry, and act in conjunction with the light, so that when a motion is detected, it will illuminate the night light, perhaps even to a higher intensity, and even emit some sounds, in the manner as previously reviewed.

The subject matter of this invention as depicted in the various models as disclosed can vary extensively, as any type of a vehicle, tank, airplane, vessel, or other structure or shape that may catch the fancy of a child, and when installed, can function as the night light, or generate some sound, during its usage. These are all envisioned within the concept of this invention. Furthermore, various types of sounds may emanate from the night light structure, in the manner as previously summarized, for this invention, and it may be actuated manually, as by a switch, or through a motion detecting device or a heat sensing instrument.

Variations or modifications to the subject matter of this invention may occur to those skilled in the art upon review of the invention as disclosed herein. Such variations, if within the spirit of this development, are intended to be encompassed within the scope of any invention as explained. The description of the preferred embodiment, and its depiction in the drawings, are set forth for illustrative purposes only.

1. A device to provide limited light generally at night in a residence, comprising:
a lamp reflector having a hollow selected shape and being partially translucent; and,
a means to illuminate contained within said lamp reflector, including a switch, a light source, wiring from said light source in connection with said switch, and contact joined to said wiring for connecting to an electrical supply.

2. The limited light device of claim 1 wherein said lamp reflector is selected from one of land vehicles, watercraft, aircraft, spacecraft, structures, animals, caricatures, or faces; and,
said light source is one of incandescent lamp, light emitting diode, fluorescent bulb, fiber optics, electro-luminescence, or liquid crystal display.

3. The limited light device of claim 2 wherein said lamp reflector is one of a racing car or a military tank.

4. The limited light device of claim 1 wherein said switch is operated by one of a lever, button, toggle, motion sensor, light sensor, or thermal sensor.

5. The limited light device of claim 4 further comprising:
said illuminating means having a sensor, a speaker, and electrical circuitry wherein said sensor signals said circuitry and said circuitry causes said speaker to generate a sound compatible to said lamp reflector and temporarily to brighten said light source.

6. The limited light device of claim 4 further comprising:
said illuminating means having a sensor, a motorized feature including a motor, and electrical circuitry wherein said sensor signals said circuitry and said circuitry causes said motorized feature to move a feature and temporarily to brighten said light source.
